(19) United States
(12) Patent Application Publication
(10) Pub. No.: US 2003/0230437 A1
(43) Pub. Date: Dec. 18, 2003

(54) Method and apparatus for weighing

(76) Inventor: Jon Thor Olafsson, Gardabaer (IS)

Correspondence Address: Steven S. Payne, 8027 ILIFF Drive, Dunn Loring, VA, 22027, US

(21) Appl. No.: 10/385,736

(22) Filed: Mar. 12, 2003

(30) Foreign Application Priority Data
Sep. 12, 2000 (IS) 5626/2000

(51) Int. Cl. G01G 19/00

(52) U.S. Cl. 177/145

(57) ABSTRACT

A method and apparatus for weighing by a conveyor-type weighing unit is disclosed, where a conveyor belt forming an endless loop is transported along a guiding unit, defining a first conveying direction and extending in-between the top sides of opposite arranged rollers. The guiding unit is tilted upwardly from the horizontal plane and thereby forming an upwardly inclined path for the belt. The conveyor belt is equipped with dividers forming a number of object receiving slots. Thereby, it is possible to conduct weighing of a single object without disturbance from the next object.

### TECHNICAL FIELD

The invention relates to a method and apparatus for weighing by conveyor-type weighing unit, where a conveyor belt forming an endless loop is transported along a guiding unit, defining a first conveying direction and extending in-between the top sides of a opposite arranged rollers. The belt is driven in a revolving manner and transported over a weighing device in conveying direction. The weighing device being a part of the guiding unit performs continuos weighing of objects transported along the conveyor.

### BACKGROUND OF THE INVENTION

Conveyor weighing technique has been known for quite some time. Conveyor weighing apparatus have mainly been used for weighing of bulk material, such as grain, rocks and other materials. There is however a growing need for accurate and high speed weighing units, both for continuous weighing of bulk material and for weighing and grading of individual objects such as food pieces. In many fields of food processing it is essential to measure as exact as possible the weight of an object being processed, prior to various types of operations, such as sorting/grading, cutting, or packaging. The weighing of individual food pieces transported along a conveyor is today an very important operation in processing of f.ex., fish-fillets and trimming of meat. If one has to weigh every object individually on a stationary weighing unit, the total processing speed would be diminished.

There is no question that the aforementioned applies not only to processing of fish and meat, but also to other types of food. The main disadvantage of the existing conveyor-type weighing apparatus, especially those available for the food processing industry is lack of robustness and accuracy.

### BRIEF DESCRIPTION OF THE INVENTION

The aim of the invention is to provide accurate conveyor-type weighing unit capable of weighing objects of varying dimension transported on a conveyor belt and eliminate the influence of adjacent objects on the conveyor when weighing a particular object.

Most conveyor type weighing devices must have the objects positioned on the conveyor belt with certain minimum distance between to objects. It is time consuming to place every object with a certain minimum distance from the next object. Most often is it the length of the weighing platform that determines the minimum distance between the objects. If the objects are to close to each other, weighing of a single object alone can not be conducted.

It is therefore the aim of this invention to provide device capable of overcoming these disadvantages of the known methods

The conveyor type weighing unit according to the invention described herein, is characterised in the that guiding unit of the weighing device is tilted upwardly from the horizontal plane and thereby forms an upwardly incline conveying path for the belt. The conveyor belt is equipped with dividers forming number of object receiving slots. By this, each object is divided into certain receiving slot. Further by tilting the guiding unit upwardly in the conveying direction the objects are directed, by force of gravity, towards the next divider behind them, forming the end of the receiving slot. Thereby it is achieved that the distance between two adjacent objects always be the same or very close to the distance between two adjacent dividers. By adjusting the length of the platform to the distance between the dividers, weighing of every object can be obtained. Also the distance between the dividers being equal or greater than the length of the weighing platform of the weighing means.

Further the invention is characterised in that the tilting of the guiding unit is about 10-60°, preferably 25-50°, most preferably about 35-45° from the horizontal plane.

Furthermore the weighing unit comprising a conveyor belt detecting sensor for collecting information of the position of the conveyor belt transporting the objects arriving.

At last the method of weighing by this conveyor type weighing device is characterised in that the first conveying direction being tilted upwardly from the horizontal plane, the conveyor belt being equipped with dividers forming number of object receiving slots in the belt, the objects to be weighed being placed therein, the objects being separated from each other by the dividers and the force of gravity as the belt is transported in the tilted position, the objects therefor leaning against the dividers as transported over the weighing unit. Also the distance between the dividers is made equal or greater than the length of the weighing platform of the weighing means.

### BRIEF DESCRIPTION OF THE DRAWINGS

The invention is explained in greater details with reference to the accompanying drawings, in which

FIG. 1 shows a side view of the tilted weighing device with a processing machine,

FIG. 2 shows the weighing device seen form above,

FIG. 3 shows a cross sectional cut of the weighing platform.

### DETAILED DESCRIPTION OF THE PRSENTLY PREFERRED EXEPLARY EMBODIMENT OF THE INVENTION

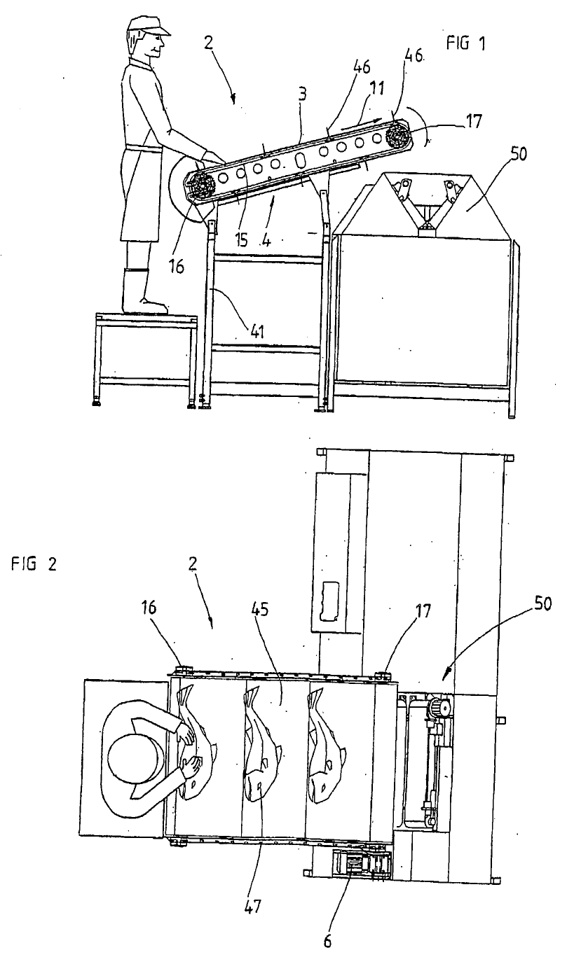

The apparatus illustrated in the FIG. 1 and 2 comprises a conveyor-type weighing unit (2) arranged on a stationary supporting frame structure (41). A conveyor belt (3) being a part of the conveyor-type weighing unit forms an endless loop unit, which is driven in a revolving manner by a driving unit (6). The conveyor belt is transported along a guiding unit (15) arranged in direction extending in-between the top sides of reversing rollers (16, 17). The belt is arranged with number of dividers (46) dividing the belt up to slots (45) for the objects to be weighed. A weighing means (4) is incorporated as a part of the guiding unit and thereby forming a part of a platform the conveyor belt is transported along. As the belt is transported along the guiding unit (15) continuous weighing measurement are made by the weighing means. The section of the belt (L₁) placed over the weighing platform (7) is weighed at each time. A computer data processing unit (not shown) is connected to respective parts of the equipment for monitoring and controlling the operation. The weighing unit is connected to a fish processing machine (50) of any preferred type that requires in-weighing of the objects prior to processing.

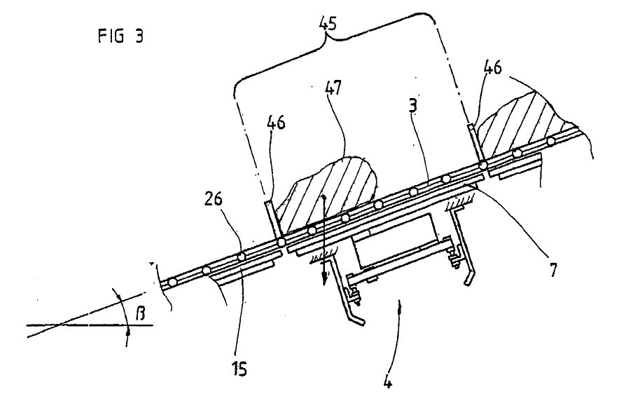

FIG. 3 shows cross sectional cut of the weighing platform. The weighing unit is tilted upwardly about the angle E, which can be about 10-60°, depending on the nature of the object to be weighed. More preferably 25-50°, most preferably about 35-45° from the horizontal plane. The object to be weighed is by force of gravity forced against the upper side of the divider (46) forming the object receiving slots (45). When the object receiving slot (45) is placed over the weighing platform (7) a weighing is performed. By this method each object to be weighed is by force of gravity placed against the upper side of the divider wall (46) and thereby forming uniform distance between the next objects. By simple trigonometry, taking into account the tilting angle E, the actual weight of the object can be achieved.

The objects (47) to be weighed are placed one by one in a receiving slot (45) on the conveyor belt (3). As the guiding unit (15) for the belt is tilted upwardly in the conveying direction, preferably around 35-45°, the object is automatically moved toward the next dividing wall (46) behind the object. This is due to the movement of the belt and the tilting and thereby increased force on the object towards the dividing wall. By this it is possible to minimise the spacing needed between the objects.

It thus will be appreciated that the objects of the present invention have been fully and effectively accomplished. It will be realised, however, that the foregoing preferred specific embodiment has been shown and described for the purpose of this invention and are subject to change without departure from its basic principles. Therefor, this invention includes all modifications and equivalents encompassed with the spirit and scope of the following patent claims.

1. Conveyor-type weighing unit (2) for weighing objects transported along a conveyor, comprising; a frame (41), a conveyor belt (3) forming an endless loop, a guiding unit (15), defining a first conveying direction (11) extending in-between the top sides of two opposite arranged rollers (16, 17), a weighing device (4) forming a part of the first guiding unit, the belt driven in a revolving manner by a driving unit (6) and transported over the weighing device in a conveying direction, characterised in, the guiding unit (15) being tilted upwardly from the horizontal plane and thereby forming an upwardly incline conveying path for the belt, the conveyor belt (4) being equipped with dividers (46) forming number of object receiving slots (45), the distance between the dividers (46) being equal or greater than the length (L₁) of the weighing platform (7) of the weighing device.

2. Conveyor-type weighing unit (2), according to claim 1, characterised in the tilting of the guiding unit is about 10-60°, preferably 25-50°, most preferably about 35-45° from the horizontal plane.

3. Conveyor-type weighing unit (2), according to one or more of claim 1 or 2, characterised in the weighing unit (2) comprising a object detecting sensor (19) connected to the data processing unit for collecting information of the position of object receiving slots arriving on the conveyor belt.

4. Conveyor-type weighing unit (2), according to one or more of claims 1-4 characterised in the weighing unit (2) comprising a conveyor belt detecting sensor for collecting information of the position of the conveyor belt transporting the objects.

5. Method of weighing objects by a conveyor-type weighing unit (2), where the conveyor belt (3), forming a endless loop, is transported along a first guiding unit (15), defining a first horizontal conveying direction (11) extending in-between the top sides of a opposite arranged rollers (16, 17), a weighing device (4) being a part of the first guiding unit (15), the belt driven in a revolving manner by a driving unit (6) and transported over the weighing device in a conveying direction, characterised in, the first conveying direction (11) being tilted upwardly from the horizontal plane, the conveyor belt being equipped with dividers (46) forming number of object receiving slots (45) on the belt, the objects to be weighed being placed therein, the objects being separated from each other by the dividers and the force of gravity as the belt is transported in the tilted position, the objects therefor leaning against the dividers (32) as transported over the weighing unit, the distance between the dividers (46) being equal or greater than the length (L₁) of the weighing platform (7) of the weighing device.
